(19) United States
(12) Patent Application Publication
(10) Pub. No.: US 2013/0099459 A1
(43) Pub. Date: Apr. 25, 2013

(54) Air Suspension System Having A Variable Spring Rate

(71) Applicants: DONALD J. REMBOSKI, ANN ARBOR, MI (US); JAMES F. ZIECH, KALAMAZOO, MI (US)

(72) Inventors: DONALD J. REMBOSKI, ANN ARBOR, MI (US); JAMES F. ZIECH, KALAMAZOO, MI (US)

(73) Assignee: DANA HEAVY VEHICLE SYSTEMS GROUP, LLC, MAUMEE, OH (US)

(21) Appl. No.: 13/450,582

(22) Filed: Apr. 19, 2012

Related U.S. Application Data
(60) Provisional application No. 61/477,656, filed on Apr. 21, 2011.

(51) Int. Cl. B60G 17/052; B60G 17/015

(52) U.S. Cl. CPC B60G 17/0521; B60G 17/015
USPC 280/124.16; 701/37

(57) ABSTRACT

An air suspension system for a vehicle having a variable spring rate is provided. The air suspension system includes a first rigid vehicle member, a second rigid vehicle member having a cavity formed therein, a resilient reservoir, and a valve. The resilient reservoir is coupled at opposing ends to the first rigid vehicle member and the second rigid vehicle member. The valve is in fluid communication with an interior of the resilient reservoir and the cavity of the second rigid vehicle member to form an air spring having a first spring volume and a second spring volume.

### CLAIM OF PRIORITY

The present application claims priority to and incorporates by reference U.S. Provisional Application No. 61/477,656 filed Apr. 21, 2011, entitled “Air Suspension System Having A Variable Spring Rate.”

### FIELD OF THE INVENTION

The present invention relates to vehicle suspensions and an air suspension system for a vehicle having a variable spring rate and a control system thereof.

### BACKGROUND OF THE INVENTION

Air suspension systems comprising a plurality of air springs provide a number of advantages over other spring suspension systems when incorporated into vehicles. Air springs may be raised or lowered by the addition or release of air from the air spring, allowing the vehicle to have a more consistent ride height. For instance, the operator or an automated system may raise the vehicle in response to an increased load, therefore maintaining a nominal amount of suspension travel despite the increased load. Further, the operator or an automated system may lower the vehicle in response to an event such as a door of the vehicle opening or to increase vehicle stability during cornering. Air springs may also be configured to provide a very compliant ride, which may be preferred by the operator or passengers of the vehicle to increase comfort.

To provide a compliant ride to a vehicle in which they are incorporated in, air springs require a large volume of air to compress in response to suspension movement. The large volume of air therefore requires a large air spring. With space in vehicles demanding an ever-increasing premium to manufacturers, vehicles including such large air springs tend to be cost prohibitive to consumers. In addition to the large air springs, vehicles including such suspension systems typically include anti-roll mechanisms. The anti-roll mechanisms increase vehicle stability and handling during cornering, where the compliant ride becomes detrimental to the vehicle stability and handling. Incorporation of the anti-roll mechanisms, in addition to the large air springs, increases vehicle cost as well.

Conversely, small air springs, while space efficient, also have many disadvantages as well. As a result of having a smaller quantity of air to compress within the air spring, the small air spring has a higher spring rate than the large air spring. The small air springs tend to be non-compliant and offer a rougher response to suspension movement. While the small air springs may offer increased vehicle stability and handling when compared to the large air springs, the operator or passengers of the vehicle may find the vehicle the small air springs are incorporated in to have poor suspension ride qualities.

It would be advantageous to develop an air suspension system for a vehicle that is compact, reduces the number of components of a suspension system, and has a variable spring rate that is adjustable based on the operating conditions of the vehicle.

### SUMMARY OF THE INVENTION

Presently provided by the invention, an air suspension system for a vehicle that is compact, reduces the number of components of a suspension system, and has a variable spring rate that is adjustable based on the operating conditions of the vehicle, has surprisingly been discovered.

In one embodiment, the present invention is directed to an air suspension system for a vehicle comprising a first rigid vehicle member, a second rigid vehicle member having a cavity formed therein, a resilient reservoir coupled at opposing ends to the first rigid vehicle member and the second rigid vehicle member, and a valve in fluid communication with an interior of the resilient reservoir and the cavity of the second rigid vehicle member. The cavity of the second rigid vehicle member, the resilient reservoir, and the valve cooperate to form an air spring having a first spring volume and a second spring volume. The first spring volume is substantially equal to the volume of the resilient reservoir plus the volume of the cavity of the second rigid vehicle member and the second spring volume is substantially equal to the volume of the interior of the resilient reservoir.

The present invention also is directed to a method of controlling an air spring. The method comprises the steps of providing the air spring, providing a valve in fluid communication with the air spring, providing a control system in communication with the valve, providing at least one sensor in communication with the control system, generating a signal using the at least one sensor in response to a stimulus, communicating the signal from the at least one sensor to the control system, processing the signal with the control system, and positioning the valve in one of an open position, a closed position, and a partially open position. The valve in the open position forms a first spring volume and the valve in the closed position forms a second spring volume. The valve is positioned in one of the open position, the closed position, and the partially open position using the control system in response to the signal generated by the at least one sensor.

Various aspects of this invention will become apparent to those skilled in the art from the following detailed description of the preferred embodiment, when read in light of the accompanying drawings.

### BRIEF DESCRIPTION OF THE DRAWINGS

The above, as well as other advantages of the present invention, will become readily apparent to those skilled in the art from the following detailed description when considered in the light of the accompanying drawings in which:

FIG. 1 is a schematic partial cross-sectional view of an air suspension system according to an embodiment of the present invention;

FIG. 2 is a schematic partial cross-sectional view of an air suspension system according to another embodiment of the present invention;

FIG. 3 is a schematic partial cross-sectional view of an air suspension system according to another embodiment of the present invention; and

FIG. 4 is a schematic partial cross-sectional view of an air suspension system according to another embodiment of the present invention.

### DETAILED DESCRIPTION OF THE INVENTION

It is to be understood that the invention may assume various alternative orientations and step sequences, except where expressly specified to the contrary. It is also to be understood that the specific devices and processes illustrated in the attached drawings, and described in the following specification are simply exemplary embodiments of the inventive concepts defined in the appended claims. Hence, specific dimensions, directions or other physical characteristics relating to the embodiments disclosed are not to be considered as limiting, unless the claims expressly state otherwise.

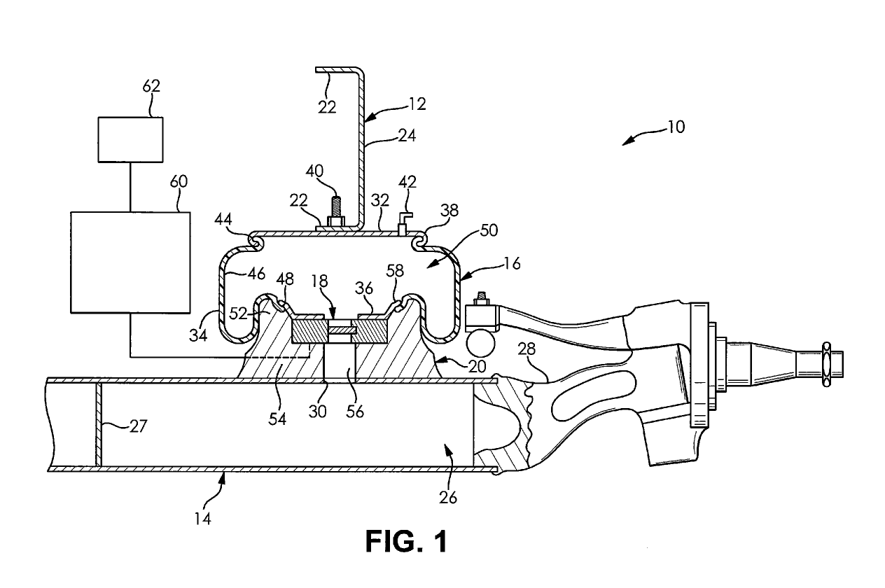

FIG. 1 illustrates an air suspension system 10 for a vehicle having a variable spring rate. The air suspension system 10 preferably includes a first rigid vehicle member 12, a second rigid vehicle member 14, a resilient reservoir 16, and a valve 18. As shown, the resilient reservoir 16 is a reversible sleeve style air spring including a piston portion 20, but it is understood the resilient reservoir 16 may be a convoluted air spring or any other type of air spring.

The first rigid vehicle member 12 is a member having a channel shaped cross-section forming a portion of a frame of the vehicle. The first rigid vehicle member 12 includes two flange portions 22 and a central portion 24. However, it is understood the first rigid vehicle member 12 may be of any shape, have any cross-section, and may be formed from a plurality of members coupled together. Preferably, the first rigid vehicle member 12 is formed from a hot rolled steel, however any other process such as stamping, casting, or machining may be used, for example. Further, the first rigid vehicle member 12 may be formed from any other rigid material such as aluminum, for example.

The second rigid vehicle member 14 is a member having a tubular cross section forming a portion of an axle of the vehicle. The second rigid vehicle member 14 defines a cavity 26 having a tube shape in at least a portion of the second rigid vehicle member 14. However, it is understood the second rigid vehicle member 14 may be of any shape, have any cross-section, and may be formed from a plurality of members coupled together. Similarly, the cavity 26 may have any length with respect to the second rigid vehicle member 14. As shown, a plate 27 is sealingly disposed within the second rigid vehicle member 14 at an intermediate position to define a volume of the cavity 26. A second plate (not shown) may be sealingly disposed within the second rigid vehicle member 14 opposite the plate 27 to define a second cavity (not shown). Preferably, the second rigid vehicle member 14 is formed from a hot rolled steel joined by a weld, however any other process such as stamping, casting, or machining may be used, for example. Further, the second rigid vehicle member 14 may be formed from any other rigid material such as aluminum, for example. The second rigid vehicle member 14 includes an axle end 28 disposed therein and an air spring aperture 30 formed therein.

The axle end 28 is an elongate member sealingly disposed in a distal end of the second rigid vehicle member 14. A weld couples the axle end 28 to the second rigid vehicle member 14. The weld seals the distal end of the second rigid vehicle member 14 with respect to an ambient environment the second rigid vehicle member 14 is placed in. It is understood that the axle end 28 may include a seal for engaging the second rigid vehicle member 14 and that the axle end 28 may be coupled to the second rigid vehicle member 14 in any conventional manner.

The air spring aperture 30 is an aperture formed through the second rigid vehicle member 14. The air spring aperture 30 facilitates fluid communication to and from the cavity 26. Similarly, a second air spring aperture (not shown) may be formed in the second rigid vehicle member 14 opposite the air spring aperture 30. As shown in FIG. 1, the air spring aperture 30 faces the first rigid vehicle member 12 and is positioned at an intermediate position along the second rigid vehicle member 14. However, the air spring aperture 30 may be formed on any side of the second rigid vehicle member 14 and at any position along a length of the second rigid vehicle member 14.

The resilient reservoir 16 is a reversible sleeve style air spring as is known in the art; however the air suspension system 10 may be adapted to employ other types of air springs. The resilient reservoir 16 includes a first bead plate 32, a bellows 34, the piston portion 20, and a second bead plate 36.

The first bead plate 32 is a circular metal plate coupled to the first rigid vehicle member 12. As shown, the first bead plate 32 has a first bead flange 38 having an arcuate shape formed about an outer periphery thereof. However, the first bead plate 32 may have any other shape and may be formed from any other material. The first bead plate 32 also includes at least one plate post 40 centrally protruding therefrom. The plate post 40 is a threaded member coupled to the first bead plate 32. As shown, the plate post 40 is inserted into a mounting aperture formed in the first rigid vehicle member 12 and secured thereto by a fastener, however, the first bead plate 32 may be secured to the first rigid vehicle member 12 by a weld or by any other fastener. An air fitting 42 is sealingly disposed in the first bead plate 32. The air fitting 42 is in fluid communication with an air line (not shown) and the resilient reservoir 16. It is understood that the air fitting 42 may also be sealingly disposed in one of the second rigid vehicle member 14 and the piston portion 20.

The bellows 34 is an elongate resilient sleeve having a first bead 44, a central portion 46, and a second bead 48. An interior volume 50 is defined by the bellows 34. The bellows 34 is formed from a fabric reinforced rubber, however, any other reinforced or non-reinforced resilient material may be used. The first bead 44 is circular in cross-section and is formed about a first distal end of the bellows 34. The first bead flange 38 compresses the first bead 44 of the bellows 34, sealingly engaging the bellows 34 with the first bead plate 32. The central portion 46 of the bellows 34 is folded. The bellows 34 includes a taper to facilitate a folding of the central portion 46. However, the bellows 34 may be formed to include the folding of the central portion 46. The second bead 48 is circular in cross-section and is formed about a second distal end of the bellows 34. As shown, the second bead 48 has a diameter smaller than a diameter of the first bead 44.

The piston portion 20 is a rigid annular body. The piston portion 20 is formed from a machined metal such as steel or aluminum. However, other metal forming processes may be used to form the piston portion 20. Further, other rigid materials such as a plastic or a composite may be used to form the piston portion 20. A first piston end 52 is a smooth lip that abuts the central portion 46 of the bellows 34. A second piston end 54 is adapted for coupling the resilient reservoir 16 to the second rigid vehicle member 14. As shown, the piston portion 20 is shaped to correspond to the second rigid vehicle member 14 and is sealingly engaged therewith. Alternately, the piston portion 20 may be shaped for coupling the piston portion 20 to a bracket. An air conduit 56 is formed through the piston portion 20 and is in fluid communication with the interior volume 50 and the cavity 26. As shown, the air conduit 56 is a stepped conduit into which the valve 18 is sealingly disposed.

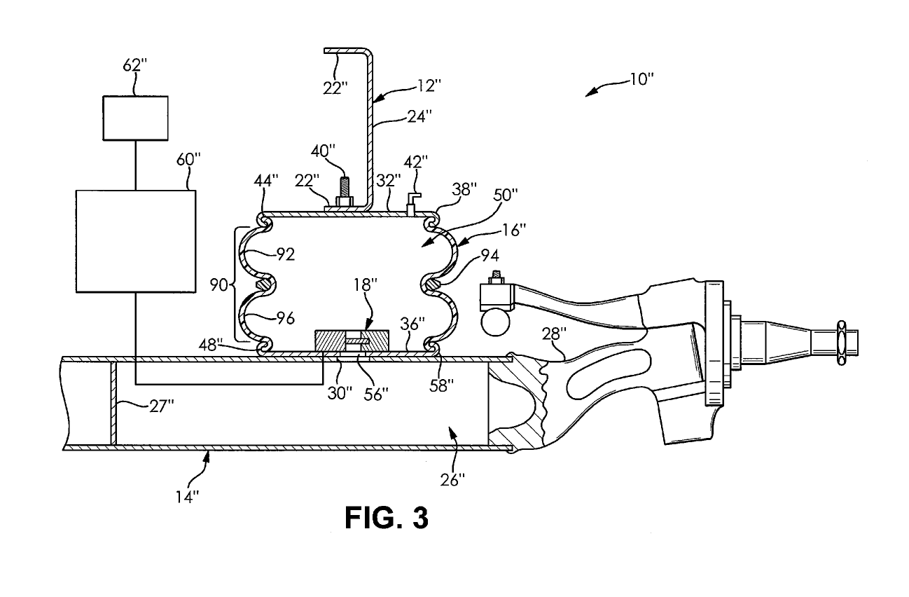

The second bead plate 36 is a rigid member coupled to the piston portion 20. As shown, the second bead plate 36 is a circular metal plate having a second bead flange 58 having an arcuate shape formed about an outer periphery thereof. However, the second bead plate 36 may have any other shape and may be formed from any other material. The second bead flange 58 compresses the second bead 48 of the bellows 34, sealingly engaging the bellows 34 with the piston portion 20. The second bead plate 36 is welded to the piston portion 20, however, the second bead plate 36 may also be coupled to the piston portion 20 with any type of fastener, such as a bolt. Further, the second bead plate 36 may be used without the piston portion 20, where the second bead plate 36 is coupled directly to the second rigid vehicle member 14, such as when the resilient reservoir 16 is a convoluted air spring, as shown in FIG. 3.

The valve 18 is a pneumatic control valve and is sealingly disposed in the air conduit 56. The valve 18 is in fluid communication with the interior volume 50 of the bellows 34 and the cavity 26 of the second rigid vehicle member 14. A control system 60 including an electronic control unit is in communication with the valve 18 and directs the valve 18 to open or close in response to a stimulus. As a non-limiting example, the valve 18 is capable of opening or closing in about 100 milliseconds. When the valve 18 is closed, the interior volume 50 of the bellows 34 is isolated from the cavity 26 of the second rigid vehicle member 14. When the valve 18 is open, the interior volume 50 of the bellows 34 and the cavity 26 of the second rigid vehicle member 14 form a single volume.

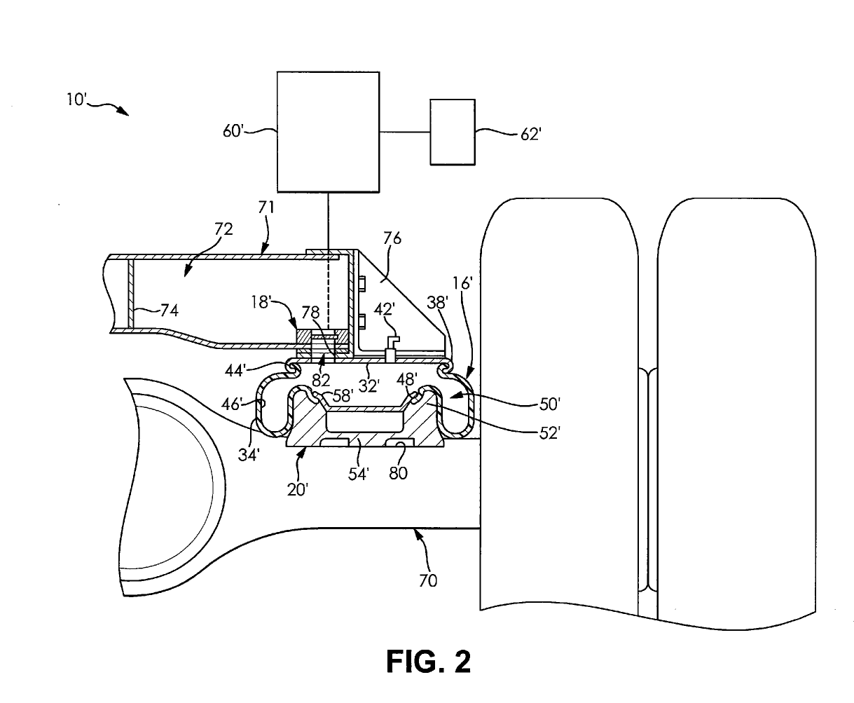

FIG. 2 shows an alternative embodiment of the air suspension system 10 for a vehicle. Similar structural features of the manifold assembly include the same reference numeral and a prime (') symbol.

FIG. 2 illustrates an air suspension system 10′ for a vehicle having a variable spring rate. The air suspension system 10′ preferably includes a vehicle axle 70, a second rigid vehicle member 71, a resilient reservoir 16′, and a valve 18′. As shown, the resilient reservoir 16′ is a reversible sleeve style air spring including a piston portion 20′, but it is understood the resilient reservoir 16′ may be a convoluted air spring or any other type of air spring.

The vehicle axle 70 is a member having a tubular cross-section. As shown in FIG. 2, the vehicle axle 70 is a non-steering axle of the vehicle; and may be a drive axle of the vehicle. The vehicle axle 70 includes a piston mount 80 adapted to receive the piston portion 20′. However, it is understood the vehicle axle 70 may be of any shape, have any cross-section, and may be formed from a plurality of members coupled together. Preferably, the vehicle axle 70 is formed from a hot rolled steel, however any other process such as stamping, forging, casting, or machining may be used, for example. Further, the vehicle axle 70 may be formed from any other rigid material such as aluminum, for example.

The second rigid vehicle member 71 is a member having a rectangular cross section forming a portion of a frame of the vehicle. The second rigid vehicle member 71 defines a cavity 72 in at least a portion of the second rigid vehicle member 71. However, it is understood the second rigid vehicle member 71 may be of any shape, have any cross-section, and may be formed from a plurality of members coupled together. Alternately, the second rigid vehicle member 71 may be a portion of a vehicle suspension system (not shown). Similarly, the cavity 72 may have any length with respect to the second rigid vehicle member 71. As shown, a plate 74 is sealingly disposed within the second rigid vehicle member 71 at an intermediate position to define a volume of the cavity 72. A second plate (not shown) may be sealingly disposed within the second rigid vehicle member 71 opposite the plate 74 to define a second cavity (not shown). Preferably, the second rigid vehicle member 71 is formed from a hot rolled steel and joined by a weld, however any other process such as stamping, forging, casting, or machining may be used, for example. Further, the second rigid vehicle member 71 may be formed from any other rigid material such as aluminum, for example. The second rigid vehicle member 71 includes a spring mount 76 and an air spring aperture 78 formed therein.

The piston portion 20′ is a rigid annular body. The piston portion 20′ is formed from a machined metal such as steel or aluminum. However, other metal forming processes may be used to form the piston portion 20′. Further, other rigid materials such as a plastic or a composite may be used to form the piston portion 20′. A first piston end 52′ is a smooth lip that abuts the central portion 46′ of the bellows 34′. A second piston end 54′ is adapted for coupling the resilient reservoir 16′ to the vehicle axle 70. As shown, the piston portion 20′ is shaped to correspond to the vehicle axle 70. Alternately, the piston portion 20′ may be shaped for coupling the piston portion 20′ to a bracket.

The first bead plate 32′ is a circular metal plate coupled to the second rigid vehicle member 71. As shown, the first bead plate 32′ has a first bead flange 38′ having an arcuate shape formed about an outer periphery thereof. However, the first bead plate 32′ may have any other shape and may be formed from any other material. As shown, the first bead plate 32′ is also coupled to the spring mount 76. The first bead plate 32′ forms a portion of the air conduit 82. The air conduit 82 is formed through the first bead plate 32′ and is in fluid communication with the interior volume 50′ and the cavity 72. As shown, the air conduit 82 is formed by aligning perforations formed in the first bead plate 32′ and the second rigid vehicle member 71. An air fitting 42′ is sealingly disposed in the spring mount 76 and the first bead plate 32′. The air fitting 42′ is in fluid communication with an air line (not shown) and the resilient reservoir 16′. It is understood that the air fitting 42′ may also be sealingly disposed in the second rigid vehicle member 71.

The second bead plate 36′ is a rigid member coupled to the piston portion 20′. As shown, the second bead plate 36′ is a circular metal plate having a second bead flange 58′ having an arcuate shape formed about an outer periphery thereof. However, the second bead plate 36′ may have any other shape and may be formed from any other material. The second bead flange 58′ compresses the second bead 48′ of the bellows 34′, sealingly engaging the bellows 34′ with the piston portion 20′. The second bead plate 36 is welded to the piston portion 20′; however, the second bead plate 36′ may also be coupled to the piston portion 20′ with any other fastener, such as a bolt.

The valve 18′ is a pneumatic control valve and is sealingly disposed in the second rigid vehicle member 71. The valve 18′ is in fluid communication with the interior volume 50′ of the bellows 34′ and the cavity 72 of the second rigid vehicle member 71. A control system 60′ is in communication with the valve 18′ and directs the valve 18′ to open or close in response to a stimulus. As a non-limiting example, the valve 18′ is capable of opening or closing in about 100 milliseconds. When the valve 18′ is closed, the interior volume 50′ of the bellows 34′ is isolated from the cavity 72 of the second rigid vehicle member 71. When the valve 18′ is open, the interior volume 50′ of the bellows 34′ and the cavity 72 of the second rigid vehicle member 71 form a single volume.

FIG. 3 shows an alternative embodiment of the air suspension system 10 for a vehicle. Similar structural features of the manifold assembly include the same reference numeral and a double prime (″) symbol.

FIG. 3 illustrates an air suspension system 10″ for a vehicle having a variable spring rate. The air suspension system 10″ preferably includes a first rigid vehicle member 12″, a second rigid vehicle member 14″, a resilient reservoir 16″, and a valve 18″. As shown, the resilient reservoir 16″ is a convoluted style air spring. The resilient reservoir 16″ is a convoluted style air spring as is known in the art, however the air suspension system 10″ may be adapted to employ other types of air springs. The resilient reservoir 16″ includes a first bead plate 32″, a convoluted bellows 90, and a second bead plate 36″.

The convoluted bellows 90 is an elongate resilient sleeve having a first bead 44″, a first convolution 92, a girdle 94, a second convolution 96, and a second bead 48″. An interior volume 50″ is defined by the bellows 34″. The bellows 34″ is formed from a fabric reinforced rubber, however, any other reinforced or non-reinforced resilient material may be used. The first bead 44″ is circular in cross-section and is formed about a first distal end of the bellows 34″. The first bead flange 38″ compresses the first bead 44″ of the bellows 34″, sealingly engaging the bellows 34″ with the first bead plate 32″. The first convolution 92 of the bellows 34″ has an arcuate, annular shape and is unitary with the first bead 44″ and the second convolution 96. The girdle 94 is disposed about a central portion of the bellows 34″ and is ring shaped. The girdle 94 is formed from a material similar to the bellows 34″ and molded therewith, but any other material and coupling may be used. The second convolution 96 of the bellows 34″ has an arcuate, annular shape and is unitary with the second bead 48″ and the first convolution 92. The second bead 48″ is circular in cross-section and is formed about a second distal end of the bellows 34″. As shown, the second bead 48″ has a diameter equal to a diameter of the first bead 44″; however, it is understood other diameters may be used.

The second bead plate 36″ is a rigid member coupled to the second rigid vehicle member 14″. As shown, the second bead plate 36″ is a circular metal plate having a second bead flange 58″ having an arcuate shape formed about an outer periphery thereof. However, the second bead plate 36″ may have any other shape and may be formed from any other material. The second bead flange 58″ compresses the second bead 48″ of the bellows 34″, sealingly engaging the bellows 34″ with the second bead plate 36″. The second bead plate 36″ is coupled to the second rigid vehicle member 14″, however, the second bead plate 36″ may also be coupled to the second rigid vehicle member 14″ with any other fastener, such as a weld.

The valve 18″ is a pneumatic control valve and is sealingly disposed against the second bead plate 36″ to form a portion of the air conduit 56″. The valve 18″ is in fluid communication with the interior volume 50″ of the bellows 34″ and the cavity 26″ of the second rigid vehicle member 14″. A control system 60″ including an electronic control unit is in communication with the valve 18″ and directs the valve 18″ to open or close in response to a stimulus. As a non-limiting example, the valve 18″ is capable of opening or closing in about 100 milliseconds. When the valve 18″ is closed, the interior volume 50″ of the bellows 34″ is isolated from the cavity 26″ of the second rigid vehicle member 14″. When the valve 18″ is open, the interior volume 50″ of the bellows 34″ and the cavity 26″ of the second rigid vehicle member 14″ form a single volume.

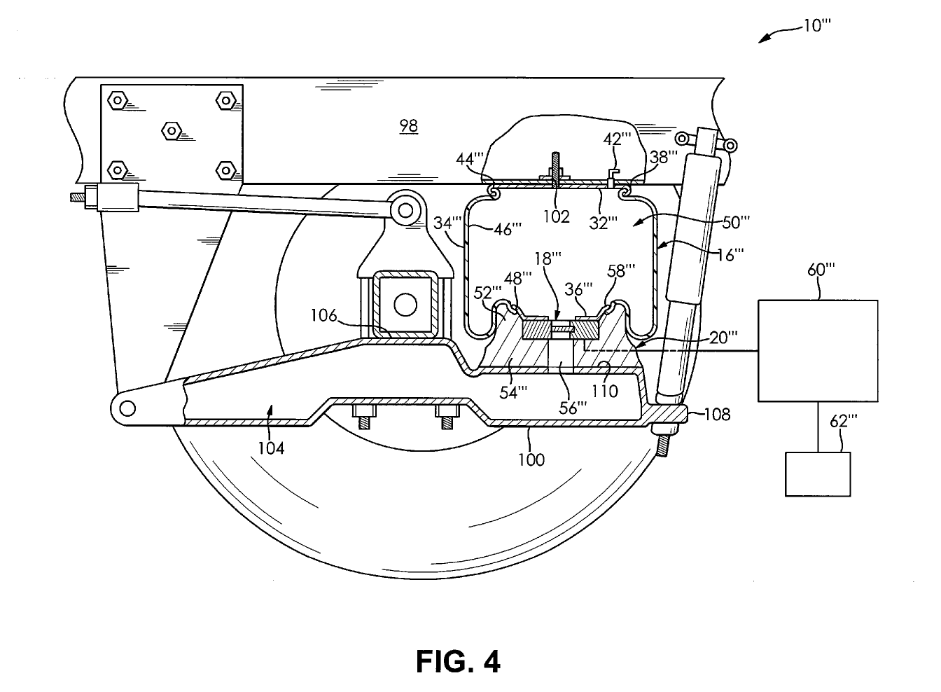

FIG. 4 shows an alternative embodiment of the air suspension system 10 for a vehicle. Similar structural features of the manifold assembly include the same reference numeral and a triple prime (′″) symbol.

FIG. 4 illustrates an air suspension system 10′″ for a vehicle having a variable spring rate. The air suspension system 10′″ preferably includes a first rigid vehicle member 98, a suspension member 100, a resilient reservoir 16′″, and a valve 18′″. As shown, the resilient reservoir 16′″ is a reversible sleeve style air spring including a piston portion 20′″, but it is understood the resilient reservoir 16″ may be a convoluted air spring or any other type of air spring.

The first rigid vehicle member 98 is a member having a rectangular cross section forming a portion of a frame of the vehicle. However, it is understood the first rigid vehicle member 98 may be of any shape, have any cross-section, and may be formed from a plurality of members coupled together. Preferably, the first rigid vehicle member 98 is formed from a hot rolled steel, however any other process such as stamping, forging, casting, or machining may be used, for example. Further, the first rigid vehicle member 98 may be formed from any other rigid material such as aluminum, for example. The first rigid vehicle member 98 includes a spring mount aperture 102 formed therein.

The suspension member 100 is a member having a cavity 104 formed therein. As shown in FIG. 4, the suspension member 100 forms a portion of a vehicle suspension system. Further, as shown in FIG. 4, the suspension member 100 may include an axle mount 106 and a shock absorber mount 108 formed therewith. The suspension member 100 includes a piston mount 110 adapted to receive the piston portion 20′″. The suspension member 100 may be of any shape, have any cross-section, and may be formed from a plurality of members coupled together. Preferably, the suspension member 100 is formed from a hot rolled steel, however any other process such as stamping, forging, casting, or machining may be used, for example. Further, suspension member 100 may be formed from any other rigid material such as aluminum, for example.

The piston portion 20′″ is a rigid annular body. The piston portion 20′″ is formed from a machined metal such as steel or aluminum. However, other metal forming processes may be used to form the piston portion 20′″. Further, other rigid materials such as a plastic or a composite may be used to form the piston portion 20″. A first piston end 52″ is a smooth lip that abuts the central portion 46″ of the bellows 34″. A second piston end 54″ is adapted for coupling the resilient reservoir 16′″ to the suspension member 100. As shown, the piston portion 20′″ is shaped to correspond to the suspension member 100. Alternately, the piston portion 20″ may be shaped for coupling the piston portion 20′″ to a bracket or other member interposed between the piston portion 20′″ and the suspension member 100. An air conduit 56″ is formed through the piston portion 20″ and is in fluid communication with the interior volume 50′″ and the cavity 104. As shown, the air conduit 56″ is a stepped conduit into which the valve 18′″ is sealingly disposed.

The first bead plate 32″ is a circular metal plate coupled to the first rigid vehicle member 98. As shown, the first bead plate 32″ has a first bead flange 38″ having an arcuate shape formed about an outer periphery thereof. However, the first bead plate 32″ may have any other shape and may be formed from any other material. As shown, the first bead plate 32′″ coupled to the first rigid vehicle member 98 through the spring mount aperture 102. An air fitting 42″ may be sealingly disposed in the first bead plate 32″ through the first rigid vehicle member 98. The air fitting 42′ is in fluid communication with an air line (not shown) and the resilient reservoir 16″. It is understood that the air fitting 42″ may also be sealingly disposed in the piston portion 20′″.

The second bead plate 36″ is a rigid member coupled to the piston portion 20′″. As shown, the second bead plate 36″ is a circular metal plate having a second bead flange 58″ having an arcuate shape formed about an outer periphery thereof. However, the second bead plate 36″ may have any other shape and may be formed from any other material. The second bead flange 58′″ compresses the second bead 48″ of the bellows 34″, sealingly engaging the bellows 34″ with the piston portion 20′″. The second bead plate 36″ is welded to the piston portion 20′″; however, the second bead plate 36″ may also be coupled to the piston portion 20′″ with any other fastener, such as a bolt. As shown, fluid communication between the interior volume 50′″ and the cavity 104 is afforded by aligning the air conduit 56″ with perforations formed in the second bead plate 36″ and the suspension member 100.

The valve 18′″ is a pneumatic control valve and is sealingly disposed in the air conduit 56″. The valve 18′″ is in fluid communication with the interior volume 50′″ of the bellows 34′″ and the cavity 104 of the suspension member 100. A control system 60′″ including an electronic control unit is in communication with the valve 18′″ and directs the valve 18′″ to open or close in response to a stimulus. As a non-limiting example, the valve 18′″ is capable of opening or closing in about 100 milliseconds. When the valve 18′″ is closed, the interior volume 50′″ of the bellows 34′ is isolated from the cavity 104 of the suspension member 100. When the valve 18′″ is open, the interior volume 50′″ of the bellows 34′ and the cavity 104 of the suspension member 100 form a single volume.

In use, the air suspension system 10, 10′, 10″, 10″ provides the variable spring rate that is adjustable based on the operating conditions of the vehicle the air suspension system 10, 10′, 10″, 10′″ is incorporated in. At least one sensor 62, 62′, 62″, 62″ is in communication with the control system 60, 60′, 60″, 60″. As non-limiting examples, the at least one sensor 62, 62′, 62″, 62′″ may be one of a temperature sensor, a pressure sensor, a speed sensor, a lateral acceleration sensor, a longitudinal acceleration sensor, a turn angle sensor, a vehicle brake sensor, a vehicle roll rate sensor, a vehicle load sensor, a vehicle grade slope sensor, or any other sensor typically employed in vehicles. The control system 60, 60′, 60″, 60′″ may include an adaptive control logic.

The adaptive control logic compensates an output of the control system over time for at least one of a shift time, a fluid temperature, a fluid pressure, and a shift system force of the vehicle. The control system 60, 60′, 60″, 60″ is also in communication with an air compressor (not shown). The compressor is in fluid communication with the air fitting 42, 42′, 42″, 42″ via the air line. An operator of the vehicle or the control system 60, 60′, 60″, 60′″ may adjust a “ride height” of the vehicle by adding air using the compressor or by releasing compressed air from the air suspension system 10, 10′, 10″, 10′″.

In a first mode of operation, the air suspension system 10, 10′, 10″, 10′″ employs a first spring volume and the valve 18, 18′, 18″, 18′″ is positioned in an open position. In the open position, the valve 18, 18′, 18″, 18′″ cannot be opened any further and flow therethrough is least restricted. The first spring volume comprises the interior volume 50, 50′, 50″, 50′″ of the bellows 34, 34′, 34″, 34″ and the cavity 26, 72, 26″, 104 of the second rigid vehicle member 14, 71, 14″ or the suspension member 100. The stimulus causes the at least one sensor 62, 62′, 62″, 62″ to generate a signal. The signal is communicated to the control system 60, 60′, 60″, 60′″ and processed by a control system algorithm. The control system 60, 60′, 60″, 60′″ then positions the valve 18, 18′, 18″, 18″ in an open position. In response to the stimulus when placed in the first mode of operation, the air suspension system 10, 10′, 10″, 10′″ exhibits the performance characteristics of an air spring having a volume greater than the interior volume 50, 50′, 50″, 50′″ of the bellows 34, 34′, 34″, 34′. As a non-limiting example, the air suspension system 10, 10′, 10″, 10′″ placed in the first mode of operation may exhibit a spring rate of about 900 pounds per inch. Further, the control system algorithm may direct the control system 60, 60′, 60″, 60′″ to position the valve 18, 18′, 18″, 18′″ in a partially open position. In the partially open position, the valve 18, 18′, 18″, 18′″ may be opened partially and flow therethrough is partially restricted. In the partially open position, the valve 18, 18′, 18″, 18″ may be dynamically modulated to throttle a fluid flow between the interior volume 50, 50′, 50″, 50′″ of the bellows 34, 34′, 34″, 34′″ and the cavity 26, 72, 26″, 104 of the second rigid vehicle member 14, 71, 14″ or the suspension member 100. Further, the valve 18, 18′, 18″, 18′″ is capable of being placed in a partially open position from one of the open position and the closed position in about 100 milliseconds.

In a second mode of operation, the air suspension system 10, 10′, 10″, 10′″ employs a second spring volume and the valve 18, 18′, 18″, 18′ is positioned in a closed position. In the closed position, the valve 18, 18′, 18″, 18″ prevents flow therethrough. The second spring volume comprises the interior volume 50, 50′, 50″, 50′″ of the bellows 34, 34′, 34″, 34′″. The stimulus causes the at least one sensor 62, 62′, 62″, 62″ to generate a signal. The signal is communicated to the control system 60, 60′, 60″, 60′″ and processed by the control system 60, 60′, 60″, 60′″. The control system 60, 60′, 60″, 60′″ then positions the valve 18, 18′, 18″, 18′″ in a closed position. In response to the stimulus when placed in the second mode of operation, the air suspension system 10, 10′, 10″, 10″ exhibits the performance characteristics of an air spring having a volume of the bellows 34, 34′, 34″, 34″. As a non-limiting example, the air suspension system 10, 10′, 10″, 10′″ placed in the second mode of operation may exhibit a spring rate of about 3000 pounds per inch.

When directed to by the control system 60, 60′, 60″, 60′″ in response to the stimulus detected by the at least one sensor 62, 62′, 62″, 62″, the air suspension system 10, 10′, 10″, 10′″ may quickly change from the first mode of operation into the second mode of operation or the air suspension system 10, 10′, 10″, 10′″ may quickly change from the second mode of operation into the first mode of operation to change stability and handling characteristics of the vehicle the air suspension system 10, 10′, 10″, 10′″ is incorporated in. As a non-limiting example, the air suspension system 10, 10′, 10″, 10′″ may change from the first mode of operation into the second mode of operation in response to an increased vehicle roll rate detected by the at least one sensor 62, 62′, 62″, 62′″. As a second non-limiting example, the air suspension system 10, 10′, 10″, 10′″ may change from the second mode of operation into the first mode of operation in response to a decreased front wheel turn angle and a decreased lateral acceleration rate of the vehicle detected by the at least one sensor 62, 62′, 62″, 62′″. Alternately, the air suspension system 10, 10′, 10″, 10′″ may change from one of the first mode of operation to the second mode of operation and from the second mode of operation to the first mode of operation in a time dependent proportional manner by dynamically throttling the valve 18, 18′, 18″, 18′″ in a plurality of the partially open positions dependent on the control system 60, 60′, 60″, 60′″ in response to the vehicle stimuli as detected by the at least one sensor 62, 62′, 62″, 62′″.

In accordance with the provisions of the patent statutes, the present invention has been described in what is considered to represent its preferred embodiments. However, it should be noted that the invention can be practiced otherwise than as specifically illustrated and described without departing from its spirit or scope.

What is claimed is:

1. An air suspension system for a vehicle, comprising:
a first rigid vehicle member;
a second rigid vehicle member having a cavity formed therein;
a resilient reservoir coupled at opposing ends to the first rigid vehicle member and the second rigid vehicle member; and
a valve in fluid communication with an interior of the resilient reservoir and the cavity of the second rigid vehicle member, wherein the cavity of the second rigid vehicle member, the resilient reservoir, and the valve cooperate to form an air spring having a first spring volume and a second spring volume, the first spring volume substantially equal to the volume of the resilient reservoir plus the volume of the cavity of the second rigid vehicle member and the second spring volume substantially equal to the volume of the interior of the resilient reservoir.

2. The air suspension system according to claim 1, wherein the resilient reservoir is one of a reversible sleeve style air spring and a convoluted style air spring.

3. The air suspension system according to claim 1, wherein the second rigid vehicle member is a portion of one of an axle of the vehicle, a vehicle suspension system, and a vehicle frame.

4. The air suspension system according to claim 1, wherein the first rigid vehicle member is a portion of one of a frame of the vehicle, an axle of the vehicle, and a vehicle suspension system.

5. The air suspension system according to claim 1, wherein the second rigid vehicle member has an air spring aperture formed therein, the air spring aperture facilitating fluid communication between the cavity of the second rigid vehicle member and the resilient reservoir.

6. The air suspension system according to claim 1, wherein the valve is a pneumatic control valve capable of one of opening and closing in about 100 milliseconds.

7. The air suspension system according to claim 1, wherein the valve is a pneumatic control valve capable of being placed in a partially open position from one of an open position and a closed position in about 100 milliseconds.

8. The air suspension system according to claim 1, wherein the valve is a pneumatic control valve capable of being dynamically placed into a plurality of partially open positions in a time dependent proportional manner.

9. The air suspension system according to claim 1, wherein the resilient reservoir includes a piston portion the valve is sealingly disposed in.

10. The air suspension system according to claim 1, wherein the valve is sealingly disposed in the second rigid vehicle member.

11. The air suspension system according to claim 1, wherein the valve is sealingly disposed on one of a first bead plate and a second bead plate of the resilient reservoir.

12. The air suspension system according to claim 1, wherein the air spring having a first spring volume has a spring rate of about 900 pounds per inch.

13. The air suspension system according to claim 1, wherein the air spring having a second spring volume has a spring rate of about 3000 pounds per inch.

14. The air suspension system according to claim 1, wherein the valve is in communication with a control system, the control system also in communication with at least one of a temperature sensor, a pressure sensor, a speed sensor, a lateral acceleration sensor, a longitudinal acceleration sensor, a turn angle sensor, a vehicle brake sensor, a vehicle roll rate sensor, a vehicle load sensor, and a vehicle grade slope sensor.

15. The air suspension system according to claim 14, wherein the control system includes an adaptive control logic, the adaptive control logic compensating over time for changes in at least one of a shift time, a fluid temperature, a fluid pressure, and a shift system force of the vehicle.

16. A method of controlling an air spring, comprising:
providing the air spring;
providing a valve in fluid communication with the air spring, the valve in an open position forming a first spring volume and the valve in a closed position forming a second spring volume;
providing a control system in communication with the valve;
providing at least one sensor in communication with the control system;
generating a signal using the at least one sensor in response to a stimulus;
communicating the signal from the at least one sensor to the control system;
processing the signal with the control system; and
positioning the valve in one of the open position, the closed position, and a partially open position with the control system in response to the signal generated by the at least one sensor.

17. The method according to claim 16, wherein the air spring is one of a reversible sleeve style air spring and a convoluted style air spring.

18. The method according to claim 16, wherein at least a portion of the first spring volume comprises a portion of one of a frame of a vehicle and a portion of a suspension system of the vehicle.

19. The method according to claim 16, wherein the air spring is coupled to a portion of a frame of a vehicle and one of an axle of a vehicle and a portion of a suspension system of the vehicle.

20. The method according to claim 19, wherein at least a portion of the first spring volume comprises a portion of the axle.
